(19) United States
(12) Patent Application Publication
(10) Pub. No.: US 2014/0280808 A1
(43) Pub. Date: Sep. 18, 2014

(54) DYNAMIC ROUTING FRAMEWORK

(71) Applicant: Benbria Corporation, Ottawa (CA)

(72) Inventors: Ying Du, Ottawa (CA); Drew Joseph Martin, Ottawa (CA); Nicolas Porter, Ottawa (CA)

(73) Assignee: Benbria Corporation, Ottawa (CA)

(21) Appl. No.: 14/211,730

(22) Filed: Mar. 14, 2014

Related U.S. Application Data
(60) Provisional application No. 61/792,516, filed on Mar. 15, 2013.

(51) Int. Cl. H04L 12/24

(52) U.S. Cl. CPC H04L 41/0806
USPC 709/222

(57) ABSTRACT

A system to enable dynamic routing for one or more businesses, comprising: one or more servers to create one or more platforms corresponding to the one or more businesses, wherein each of the one or more platforms is associated with one or more routing configurations, and said associated one or more routing configurations based on one or more characteristics of said corresponding business.

### CROSS REFERENCE TO RELATED APPLICATIONS

This application claims the benefit of U.S. Provisional Application No. 61/792,516, filed Mar. 15, 2013 which is hereby incorporated by reference herein in its entirety.

### FIELD OF THE INVENTION

The present disclosure relates to creating platforms for systems which will host one or more business accounts or one or more department accounts with different workflow requirements.

### BRIEF SUMMARY

A system to enable dynamic routing for one or more businesses, comprising: one or more servers to create one or more platforms corresponding to the one or more businesses, wherein each of the one or more platforms is associated with one or more routing configurations, and said associated one or more routing configurations based on one or more characteristics of said corresponding business.

Each of the one or more routing configurations is associated with one or more actions.

Each of the one or more platforms is associated with a base routing configuration and one or more specific routing configurations.

Each of the one or more businesses is associated with a corresponding business account routing configuration.

A method to enable dynamic routing for one or more businesses, comprising: creating, using one or more servers, one or more platforms corresponding to one or more businesses, wherein each of the one or more platforms is associated with one or more routing configurations, and said associated one or more routing configurations based on one or more characteristics of said corresponding business.

The foregoing and additional aspects and embodiments of the present disclosure will be apparent to those of ordinary skill in the art in view of the detailed description of various embodiments and/or aspects, which is made with reference to the drawings, a brief description of which is provided next.

### BRIEF DESCRIPTION OF THE DRAWINGS

The foregoing and other advantages of the disclosure will become apparent upon reading the following detailed description and upon reference to the drawings.

FIG. 1 shows an example of architecture for enterprise system 100.

FIG. 2 shows an example of a multiple server implementation of server(s) 105.

FIG. 3 shows a hierarchy for a specific business account.

FIG. 4 shows an example flow chart for hierarchical lookup for the first level of a hierarchy.

FIG. 5 shows an example flow chart for hierarchical lookup for the second level of a hierarchy.

While the present disclosure is susceptible to various modifications and alternative forms, specific embodiments or implementations have been shown by way of example in the drawings and will be described in detail herein. It should be understood, however, that the disclosure is not intended to be limited to the particular forms disclosed. Rather, the disclosure is to cover all modifications, equivalents, and alternatives falling within the spirit and scope of an invention as defined by the appended claims.

### DETAILED DESCRIPTION

FIG. 1 shows an example architecture to implement the system and method which is the subject of this specification. Enterprise system 100 comprises server(s) 105, database 106 and notification subsystem(s) 108, and may be operated and supervised by one or more administrators. Server(s) 105 are operational to, for example: Receive data from customer device(s) 101, system(s) 102, and internal system(s) 110; perform processing of data received from customer device(s) 101, system(s) 102, and internal system(s) 110; retrieve data from database 106 to assist or enable this processing; generates data and commands to, for example, enable operations at customer device(s) 101, system(s) 102 and internal system(s) 110; and transmits said data and commands to customer device(s) 101, system(s) 102 and internal system(s) 110.

In one embodiment, server(s) 105 communicates with customer device(s) 101, system(s) 102 and internal system(s) 110 using network 107. Network 107 is, for example, an internal network or an external network, telephone network, local area network (LAN), wide area network (WAN), campus or corporate area network (CAN), metropolitan area network (MAN), virtual private network (VPN), personal area network, mesh network, the Internet, or wireless network. Network 107 may comprise a plurality of subnetworks.

Customer device(s) 101 can refer to one or more customer devices, for example, laptops, desktops, mobile phones, IP phones, smartphones, phones, tablets or in-store kiosks or other customer devices such as telephones to enable a customer to interact with enterprise system 100.

In one embodiment, enterprise system 100 may be used to serve a single organization with customers, such as a corporation or business. In another embodiment, enterprise system 100 may be used to provide a Software as a Service (SaaS) offering to one or more organizations such as franchises, businesses or corporations. A particular organization may use a sub-system which is part of system(s) 102, which communicates with enterprise system 100 via network 107.

In another embodiment, enterprise system 100 may be used to serve a single organization such as a corporation or business, but wherein the business or corporation has several divisions or departments, each having different sets of customers.

Database 106 stores relevant data to enable operation of the enterprise system 100. In the embodiment where enterprise system 100 is used by an organization, database 106 may, for example, store data related to each customer of the organization. Each set of data related to each customer of the organization must be kept separate from the data relating to the other customers. In the embodiment where the organization has several different brands, or divisions or departments, it may be necessary to partition the database so that data related to each division or department is separate from the other divisions or departments. Then, within each partition, each customer of that division or department may have customer accounts or other data which must be kept separate from the data of the other customers of that division or department. Then the partition must be further divided into smaller sub-partitions to ensure that the data is kept separate.

In one embodiment, the enterprise system 100 belongs to a hosted service provider providing the service on behalf of one or more businesses or corporations. Each of these businesses or corporations may have their own customers. Then database 106 stores data to serve a plurality of businesses or corporations. In one embodiment, the database 106 must be partitioned so that data relating to each business or corporation is kept separate from data relating to other businesses or corporations. Furthermore, for each business, each customer of that business may have customer account or other customer data which must be kept separate from the customer data/accounts of the other customers of that business. Then the partitions must be divided into smaller sub-partitions to ensure separation of data.

In a further embodiment, a hosted service provider may be serving a business with one or more brands, divisions, departments or lines of business. Then within the partition for that business, there may be sub-partitions, each sub-partition corresponding to one of the one or more brands, divisions, departments or lines of business. The data related to each brand, division, department or line of business is kept separate from the data related to the other brands or lines of business which are owned by the same business. In a further embodiment, each customer of a brand or line of business may have data such as a customer account which must be kept separate from the customer data of the other customers of that brand, division, department or line of business. Then the sub-partitions must be divided into smaller sub-partitions to ensure separation of data. The database 106 can be divided into partitions of different granularity and size depending on the requirements of the enterprise system 100.

In the remainder of this document, for clarity, the term “business account” will be used to denote a partition for a business and the term “department account” will be used to denote a partition for a department. These terms are used to distinguish from the “customer accounts” of the customers of the business or department.

The server(s) 105 connect to notification subsystem(s) 108 to send notifications to customer devices 101, systems 102 or internal system(s) 110 via, for example, network 107 as necessary. These notifications may be sent via various methods, including email, phone calls, microblog update, and Short Message Service (SMS) as necessary. In one embodiment, the choice of media used to send the notifications depends on the settings that the customer has chosen. In the embodiment where the enterprise system 100 is run by a hosted service provider on behalf of one or more businesses or corporations, the administrators of the hosted service provider may work together with each business or corporation to configure the choice of media for the employees and customers of that business or corporation. In the embodiment where the enterprise system 100 is run by one organization with several divisions or departments, each division or department may choose different media depending on divisional or departmental requirements. In another embodiment, the administrators of the enterprise system 100 can also choose different notification media for each division, department, product line, employee group, customer, the entire business, or other groups of related people.

Internal system(s) 110 could be, for example, some part of the system such as that described in FIG. 1 of “System for Extracting User Feedback from a Microblog Site,” assigned Ser. No. 13/458,527, filed Apr. 27, 2012 to Du et al and herein incorporated by reference as if reproduced in its entirety; or the implementation system detailed in the section titled “The Implementation System” in the US Patent Application “System And Method For Rule-Based Information Routing and Participation,” assigned Ser. No. 13/728,240, filed Dec. 27, 2012 to Richardson. Internal system(s) 110 can also comprise employee devices. In the case where enterprise system 100 is run by a hosted service provider on behalf of one or more businesses or organizations, internal system(s) 110 may comprise the internal system(s) of each business or organization.

In an embodiment, server(s) 105 communicate with internal system(s) 110 over an internal connection such as is shown in FIG. 1. In the case where enterprise system 100 is run by a hosted service provider on behalf of one or more businesses or organizations, communications between the internal system(s) of each business or organization are kept separate from the communications between the internal system(s) of other businesses or organizations.

Various embodiments or implementations of enterprise system 100 are possible. For example, in one embodiment, enterprise system 100 is implemented using a server or servers. In another embodiment, it is implemented as a cloud-based implementation. In other embodiments, it is implemented in software, hardware or a combination of software and hardware. Similarly, various embodiments of the components of enterprise system 100, that is, server(s) 105, database 106 and notification subsystem(s) 108 are also possible. In one embodiment, these components are implemented using a server or servers. In another embodiment, these components are implemented using a cloud-based implementation. In other embodiments, these components are implemented in software, hardware or a combination of software and hardware. In addition, various software technologies and programming languages can be used in these implementations, such as Node.js server, J2EE, .NET framework, NoSQL, SQL, Java, JavaScript, Python, Ruby, C, C++, C#, and PHP.

In yet another embodiment server(s) 105 are implemented using multiple servers, each of which is interconnected by, for example, an internal network. FIG. 2 shows such an example. In FIG. 2, feedback collection system(s) 121 operates to collect, for example, inputs sent by customer device(s) 101 and system(s) 102. These could be, for example, survey results, post-survey interactions, login data, customer comments and questions, and other information sent by customers. Such data is stored by feedback collection system 121 in database 106. Feedback collection system(s) 121 also sends information to feedback processing system 122 for further processing. In addition, feedback collection system 121 transmits data to customer device(s) 101 and system(s) 102, such as data to generate user interfaces (UI), survey data, post survey interactions, and other such information. In one embodiment, feedback collection system 121 comprises an application or app server. The app server performs different tasks, such as handling all Hyper Text Transfer Protocol (HTTP) requests originating from a customer device. The app server may be, for example, implemented using multiple processing units, where multiple processes run simultaneously. In a further embodiment, there is a load balancer which distributes the workload evenly between the multiple processing units. In another embodiment, multiple servers are setup in a cluster to allow high availability and failover support. In one embodiment, multiple clusters are setup to allow for multi-region support and disaster recovery. In yet another embodiment, multiple clusters are setup to provide redundancy. In another embodiment, the feedback collection system comprises a WebSocket server. If a browser on a customer device(s) 101 attempts to communicate with the feedback collection system(s) 121 using the WebSocket protocol, the communication and subsequent interaction is handled by the WebSocket server. In yet another embodiment, partial or full UI contents are served through WebSocket connections to customer devices.

Feedback processing system(s) 122 interacts with feedback collection system(s) 121, analytic system(s) 123, database 106 and employee device(s) 111 so as to perform processing of data. Feedback processing system(s) 122 may perform various tasks including generation of surveys, selection of survey questions tailored to various criteria, facilitating post survey interactions, processing of customer comments and questions, processing of employee comments and questions, management of workflows and so on.

Analytic system(s) 123 interact with feedback processing system(s) 122, employee device(s) 111 and database 106, to perform more detailed analytical calculations, such as statistical analysis of survey results. Other examples of analysis provided by analytic system(s) 123 may include time-based, customer-based, location-based, business-unit-based or sector-based analysis so as to identify trends and correlate events to enable businesses and organizations to gain a better understanding of their operations and environment, and therefore function and perform better.

Employee devices 111 are part of internal system(s) 110. These can be, for example smartphones, tablets, laptops, desktops and other devices which are used by an employee. Employee devices 111 may be connected to feedback processing system(s) 122 and analytic system(s) 123 via internal network connections. They may also be connected to network 107. In the case where enterprise system 100 is run by a hosted service provider on behalf of one or more businesses or organizations, employee devices 111 are the devices owned by the employees of the one or more businesses or organizations. In one embodiment, employee devices 111 also include devices owned by the administrators of enterprise system 100. Employees can interact with the analytic system(s) 123 and feedback processing system(s) 122 in a variety of ways. For example, employees may instruct analytic system(s) 123 through employee devices 111 to perform the analyses outlined above to gain better understanding of their businesses or organizations.

As explained above, in some embodiments, enterprise system 100 is used by a hosted service provider to provide SaaS offerings, such as customer engagement systems for one or more businesses, and where there are, for example, one or more platforms are used by the one or more businesses. Then, for example, employees using one of employee devices 111 or internal system(s) 110, customers using one of customer device(s) 101, or businesses using system(s) 102, will use enterprise system 100 for a variety of purposes, such as, requesting information, performing processing, retrieving statistics, and so on.

As explained above, in some embodiments, enterprise system 100 is used by an organization with one or more departments, each department having different needs, to provide, for example, customer engagement systems. For instance, a hotel with one or two Quick Serve Restaurants (QSRs), non-restaurants and other service offerings will have different workflows for each of these facilities. The customer engagement requirements for each of these facilities may very well differ, requiring one or more platforms for each of these facilities. Then, for example, employees using internal systems 110 or employee devices 111, or guests using customer device(s) 101, or businesses using system(s) 102 will use enterprise system 100 to perform tasks such as providing feedback, requesting information, retrieving statistics, performing processing on different platforms.

Each of the one or more platforms has one or more associated routing configurations. Each of the one or more associated routing configurations is associated with one or more actions. The one or more actions help define which dataset and schema are used in database 106; the actions also select appropriate business logic and user interface configurations, which are implemented by, for example, server(s) 105 or feedback collection system(s) 121, feedback processing system(s) 122 and analytic system(s) 123. In one embodiment, the database, business logic, and user interface configurations define all of the available actions and routing configurations.

In one embodiment, the enterprise system 100 is capable of implementing “dynamic routing”, which means that the platform can vary from business to business, or department to department. In the explanation that follows, although it refers to businesses, the same can be easily applied to departments. In one embodiment, routing configuration may be based on characteristics associated with the business. These characteristics can be, for example, business account name, flows or domains used for the business.

In one embodiment, routing configuration may be based on business account name, that is, a business with a specific business account name can have a specific routing configuration. For example, a specific quick serve restaurant (QSR) business named ABC Fast Food may require an anonymous web interface from which a loop can be initiated. Methods and web interfaces to initiate loops have been discussed in U.S. patent application Ser. No. 13/728,240 titled “System And Method For Rule-Based Information Routing And Participation,” filed Dec. 27, 2012 and incorporated herein by reference as if reproduced in its entirety. However, for example, a specific hotel business name, ABC Hotel, may not have anonymous loop initiation. They may show, for example, an error page; or redirect a user to another page, such as a login page. Using routing configuration is more efficient to handle the different behaviours compared to, for example, writing duplicated code to check which business account is in use.

In another embodiment, routing configuration may be based on flow. Different business types have different flows. The routing configuration will differ based on the corresponding flow. In one embodiment, there may be one or more flows, each flow corresponding to one or more business types. In another embodiment, one business account may contain behaviours from multiple flows. An example is shown in Table 1:

TABLE 1
Business accounts with different flow types

| | | Flow type | | |
|---|---|---|---|---|
| | | 1 | 2 | 3 |
| Business | 1 | Yes | No | Yes |
| Account | 2 | Yes | Yes | No |
| | 3 | No | No | Yes |

For example assume there are three flow types 1, 2 and 3; and three business accounts 1, 2 and 3; as shown in Table 1. Then, for example, business account 1 has flow types 1 and 3; business account 2 has flow types 1 and 2; and business account 3 has flow type 3.

Then, there may be a specific routing configuration for each different characteristic type. So, for example in business account 1, there may be specific routing configurations achieved using a combination of flow types 1 and 3.

In another embodiment, routing configuration is based on the domain name that is used to access a business account. For example, restaurantOne.hotel.com will have a different routing configuration from restaurantTwo.hotel.com. Another example is that www.hotelABC.com will have a different routing configuration from www.restaurantABC.com

In another embodiment, the platform is associated with a base routing configuration which is the same for all business accounts, and one or more customizable specific routing configurations. The base routing configuration is associated with actions which are common to all business accounts. The specific routing configurations are customized according to the characteristics associated with the business. In one embodiment, the specific routing configurations are derived or inherited either directly or indirectly from the base routing configuration, such that the specific routing configurations override and modify the actions which are associated with the base. In another embodiment, new actions and behaviours not present in the base can be introduced to the specific routing configuration.

In one embodiment, the base and specific routing configurations for each business account are arranged into a hierarchy, comprising one or more levels. Each level corresponds to a characteristic, for example, flow. Each level may comprise one or more nodes, which in turn correspond to specific routing configurations which are customizable. At the bottom of the hierarchy is the base routing configuration. An example hierarchy for a business account is shown in FIG. 3. The hierarchy shown in FIG. 3 has 4 levels, 501-504. Each level corresponds to a different characteristic. For example, level 502 may correspond to flow, and each of nodes 502-1, 502-2 and 502-3 correspond to a specific routing configuration which matches each flow type of the business account.

The base routing configuration 505 is associated with actions which are common to all business accounts. Moving up, level 504 has node 504-1. Node 504-1 corresponds to a routing configuration which is associated with one or more actions. The one or more associated actions are inherited directly from a subset of the actions associated with the base routing configuration. In one embodiment, when the one or more actions associated with node 504-1 were inherited, they may have been overridden or modified. In another embodiment, 504-1 can introduce new actions and new behaviors not present in the base routing configuration 505.

Moving up to level 503, similarly node 503-1 and 503-2 each inherited a subset of actions from node 504-1, and in one embodiment these actions were overridden or modified when they were inherited. In another embodiment, new actions and behaviors are added to each of the node 503-1 and 503-2.

Moving up to level 502, node 502-1 inherited a subset of actions from 503-1; and 502-2 and 502-3 each inherited a subset of actions from 503-2. In one embodiment these actions were overridden or modified when they were inherited. In another embodiment, new actions and behaviors are introduced at each of the node.

Moving up to level 501, node 501-1 inherited subsets of actions from 502-1, 502-2 and 502-3. In one embodiment, these actions were overridden or modified when they were inherited. In another embodiment, new actions and behaviors are introduced at node 501-1.

Moving up to the top level 500, node 500-1 corresponds to the specific business account or business account routing configuration. Node 500-1 inherited a subset of actions from 501-1. In one embodiment, the actions may be overridden or modified. In another embodiment, new actions and behaviors are introduced at node 500-1 which is the business account level.

In one embodiment, a Uniform Resource Identifier (URI), such as a Uniform Resource Locator (URL), corresponding to a business, maps to a business account routing configuration. The routing configuration contains a configuration mapping, wherein one or more actions reside. Then, when the URI is utilized to access information, for example, when a user types in a URL using a client program such as a browser, then the appropriate actions are invoked. In one embodiment, the configuration mapping is stored in one or more route files which are also used to define the name of the one or more actions. In a further embodiment, the route files also store the names of any functions that will need to be called before the action is invoked. These route files also are used to configure the response sent to the client program after the action is invoked.

In one embodiment, there are one or more action files that specify functions that the actions map to. In a further embodiment, the execution of actions can be restricted based on user permissions. One action can correspond to multiple sub-actions, each differentiated by restrictions on the user's permissions. For example, if the user has manager permissions, the actions are very different to another scenario where the user does not have manager permissions.

In one embodiment, when a user accesses an URL, the action lookup of that URL is done hierarchically. FIGS. 4 and 5 present an example of a flowchart for hierarchical lookup for 2 levels of a hierarchy. For example, when a user makes a request to access information by typing in a URL related to a business account (step 301), then the server 105 starts at the 1^{st} level of the hierarchy and looks for the business account routing configuration corresponding to the specific business account (step 302). If the specific routing configuration is found (step 303), the server 105 then checks to see if the action requested by the URL resides in the configuration mapping (step 304). If the action is found, the server 105 then checks each sub-actions of the action to see if the user has the proper permissions for all sub-actions (step 305). If the answer in step 305 is yes, the action is invoked (step 306).

If the specific routing configuration cannot be found, or the user does not have the proper permissions, or the action is not found in the configuration mapping, then server 105 will check to see if there is another level in the hierarchy (step 307). If the answer in step 307 is no, then server 105 will check to see whether the action can be found in the base (step 309). If the answer in step 309 is no, then an error is returned (step 310). If the answer in step 309 is yes, then in step 311 the server 105 then checks to see whether the user has the proper permission for all sub-actions comprising the action. If yes, then in step 306 the action is invoked.

If the answer in step 307 is yes, then server 105 will check the 2^{nd} level of the hierarchy in step 308 as shown in FIG. 5. In the example of FIG. 5, the next level corresponds to flow type. In step 408, a check is made to see if the business account has one or more flow types. If there are one or more flow types, then in step 409, a terminal value N is set equal to the number of flow types the business account has. An index indn is set equal to 1 (step 410). In step 411, indn is checked against N. If indn≦N (step 411), then step 412 is performed. Step 412-414 are identical to steps 303-305. If the answer for each of steps 412-414 is yes, then in step 415 the action is invoked. If the answer to any of these steps is no, then indn is incremented by 1 (step 416) and the server checks to see if indn≦N (step 411).

If the answer to step 411 or step 408 is no, then in step 418 the server 105 checks to see whether there is another level in the hierarchy. If the answer in step 418 is yes, the server checks the next level of the hierarchy. If no, then in step 419 the server checks the base routing configuration. If the answer in step 419 is no, then in step 417 the server returns an error. If the answer in step 419 is yes, then a check is made to see whether the user has proper permissions for all sub-actions. If no, the server returns an error in step 417.

As can be seen, the lookup can be generalized to a hierarchy with more than 2 levels.

Although the algorithms described above including those with reference to the foregoing flow charts have been described separately, it should be understood that any two or more of the algorithms disclosed herein can be combined in any combination. Any of the methods, algorithms, implementations, or procedures described herein can include machine-readable instructions for execution by: (a) a processor, (b) a controller, and/or (c) any other suitable processing device. Any algorithm, software, or method disclosed herein can be embodied in software stored on a non-transitory tangible medium such as, for example, a flash memory, a CD-ROM, a floppy disk, a hard drive, a digital versatile disk (DVD), or other memory devices, but persons of ordinary skill in the art will readily appreciate that the entire algorithm and/or parts thereof could alternatively be executed by a device other than a controller and/or embodied in firmware or dedicated hardware in a well known manner (e.g., it may be implemented by an application specific integrated circuit (ASIC), a programmable logic device (PLD), a field programmable logic device (FPLD), discrete logic, etc.). Also, some or all of the machine-readable instructions represented in any flowchart depicted herein can be implemented manually as opposed to automatically by a controller, processor, or similar computing device or machine. Further, although specific algorithms are described with reference to flowcharts depicted herein, persons of ordinary skill in the art will readily appreciate that many other methods of implementing the example machine readable instructions may alternatively be used. For example, the order of execution of the blocks may be changed, and/or some of the blocks described may be changed, eliminated, or combined.

It should be noted that the algorithms illustrated and discussed herein as having various modules which perform particular functions and interact with one another. It should be understood that these modules are merely segregated based on their function for the sake of description and represent computer hardware and/or executable software code which is stored on a computer-readable medium for execution on appropriate computing hardware. The various functions of the different modules and units can be combined or segregated as hardware and/or software stored on a non-transitory computer-readable medium as above as modules in any manner, and can be used separately or in combination.

While particular implementations and applications of the present disclosure have been illustrated and described, it is to be understood that the present disclosure is not limited to the precise construction and compositions disclosed herein and that various modifications, changes, and variations can be apparent from the foregoing descriptions without departing from the spirit and scope of an invention as defined in the appended claims.

What is claimed is:

1. A system to enable dynamic routing for one or more businesses, comprising:
one or more servers to create one or more platforms corresponding to the one or more businesses,
wherein each of the one or more platforms is associated with one or more routing configurations, and
said associated one or more routing configurations based on one or more characteristics of said one or more businesses.

2. The system of claim 1, wherein each of said one or more routing configurations is associated with one or more actions.

3. The system of claim 1, wherein each of the one or more platforms is associated with a base routing configuration.

4. The system of claim 1, wherein each of the one or more businesses is associated with at least one corresponding business account routing configuration.

5. The system of claim 4, wherein a Uniform Resource Identifier (URI) corresponding to a first of the one or more businesses maps to at least one business account routing configuration corresponding to the first business.

6. The system of claim 3, further wherein each of the one or more platforms is associated with one or more specific routing configurations.

7. The system of claim 6, wherein for one of the one or more platforms, the base routing configuration and the one or more specific routing configurations are arranged into a hierarchy comprising one or more levels.

8. The system of claim 7, further wherein each of the base routing configuration and the one or more specific routing configurations are associated with one or more actions.

9. The system of claim 3, wherein the base routing configuration is associated with one or more actions common to the one or more businesses.

10. The system of claim 6, wherein at least one of the one or more specific routing configurations comprises one or more inherited actions.

11. The system of claim 8, further wherein a hierarchical action lookup is performed responsive to a request to access information.

12. The system of claim 2, wherein said one or more servers are connected to a database, further wherein said one or more businesses comprising a first business and a second business,
said first business associated with a first business account in said database and a first routing configuration;
said second business associated with a second business account in said database and a second routing configuration; and
further wherein at least some portion of the first routing configuration is similar to some portion of the second routing configuration.

13. The system of claim 10, wherein said one or more inherited actions are based on modification of one or more existing actions or introduction of one or more new actions.

14. The system of claim 5, wherein the URI corresponds to a second of the one or more businesses, and maps to at least one business account routing configuration corresponding to the second business.

15. The system of claim 2, wherein after one of the one or more actions is invoked, a response is configured, and the configured response is sent.

16. The system of claim 2, wherein the execution of the one or more actions is based on permissions.

17. A method to enable dynamic routing for one or more businesses, comprising:
creating, using one or more servers, one or more platforms corresponding to one or more businesses,
wherein each of the one or more platforms is associated with one or more routing configurations, and
said associated one or more routing configurations based on one or more characteristics of said one or more businesses.

18. The method of claim 17, wherein each of said one or more routing configurations is associated with one or more actions.

19. The method of claim 17, wherein each of the one or more platforms is associated with a base routing configuration.

20. The method of claim 17, wherein each of the one or more businesses is associated with at least one corresponding business account routing configuration.
